(19) United States
(12) Patent Application Publication
(10) Pub. No.: US 2023/0032258 A1
(43) Pub. Date: Feb. 2, 2023

(54) CLOUD DESIGN COMPOSITION NEGOTIATION SYSTEM

(71) Applicant: MIN-CHIEH HUANG, TAINAN CITY (TW)

(72) Inventor: MIN-CHIEH HUANG, TAINAN CITY (TW)

(21) Appl. No.: 17/387,074

(22) Filed: Jul. 28, 2021

(51) Int. Cl. G06F 30/13

(52) U.S. Cl. CPC G06F 30/13

(57) ABSTRACT

A cloud design composition negotiation system includes a cloud design composition server including a database storing design composition data. A partial change program can access variable data in a variable data section. A processing unit executes partial change in the design composition data. An execution end operating unit is linked with the database and is operable by clicking a style selection program and an area selection program to present a style selection icon and an area selection icon on a screen, thereby obtaining one of the design composition data. Icons of a composition of the one of the design composition data are shown on the screen. The partial change program presents a partial change icon on the screen. Clicking the partial change icon enables an execution end user to access the variable data section to thereby proceed with partial change in the icons of the composition.

### BACKGROUND OF THE INVENTION

The present invention relates to a commercial system and, more particularly, to a system providing negotiation of a design composition.

Decorations of architectures, such as houses, offices, malls, etc., are related to the architecture interior deployment and exhibition of taste and are, thus, widely valued. Many proprietors (or so-called “customers” or “potential customers” intending to proceed with decorations of architectures, such as houses, offices, malls, etc.) will seek professionals for front-end compositions and rear-end working of indoor designs.

Conventionally, some proprietors use screenshots or other design works as references for front-end compositions or rear-end working. However, every design has its own uniqueness and objective environment, including but not limited to size, style, price consideration, material, etc. and, thus, cannot be easily applied. Thus, oral communication and references unidirectionally provided by the proprietor cannot achieve full communication and apprehension. A run-in composition can be obtained only after mutual consultation.

Hence, the front-end composition is extremely important, as it is the initial expression of the idea and concept of design as well as the sample and blueprint of subsequent working. Many proprietors are very willing to participate in the conception. Due to the lack of professional techniques in compositions of indoor designs, a proprietor having his or her own design idea still cannot communicate specifically by oral expression of the three-dimensional space. As a result, the designer of the composition or the worker may misunderstand in communication, whereas frequent discussions take considerable time and traffic expenses, which is not economic.

### BRIEF SUMMARY OF THE INVENTION

In view of the above drawbacks in the prior art, the present invention provides a cloud design composition negotiation system comprising a cloud design composition server including a database in which a plurality of design composition data is stored. The cloud design composition server further includes a partial change program configured to link with a variable data section and to access variable data in the variable data section. The cloud design composition server further includes a processing unit configured to execute partial change in the plurality of design composition data. The cloud design composition server further includes a style selection program and an area selection program. An execution end operating unit is configured to link with the database and includes a screen. The execution end operating unit is operable by clicking the style selection program and the area selection program to present a style selection icon and an area selection icon on the screen, thereby obtaining a selected one of the plurality of design composition data. Icons of a composition of the selected one of the plurality of design composition data are shown on the screen. The partial change program is configured to present a partial change icon on the screen. Clicking the partial change icon enables an execution end user to access the variable data section to thereby proceed with partial change in the icons of the composition.

Thus, a proprietor can operate the execution end operating unit to link with the database via the Internet, and the plurality of design composition data on the screen can be clicked to show the respective design composition data on the screen. Then, the proprietor can view the icons presented by the design composition data and can express opinions on and participate in partial modification of the respective design composition data on the screen. The concrete modification can be transmitted to the composition worker for proceeding with detailed construction drawings.

The detailed construction drawings obtained from the interaction between two parties can be provided by proprietor to the worker for working. The following advantages can be obtained. Firstly, the cloud design composition negotiation system according to the present invention enables composition workers to directly communicate with the proprietor without the need of permanent personnel, and the provision of cloud data saves the manpower and the time required for traffic. Secondly, the design composition data stored in the huge database satisfies various ideas of the proprietor in the contours and spatial layouts. Thirdly, the proprietor, even without high design specialty, can participate in the modification, and such modification can be easily achieved through clicking operation of the execution end operating unit (such as a computer, a tablet, or a cell phone). Fourthly, the communication between two parties can be recorded in the cloud via the Internet and related computer equipment, which leaves a record for checking and evidence in the future.

In an example, the variable data section includes material data.

In an example, the cloud design composition server further includes a size input program which is configured to present a computer icon for size input on the screen. The size input program is configured to link with a pricing program which is configured to present a price column on the screen. When a size is inputted through the execution end operating unit, a price is calculated and shown in the price column.

The present invention will become clearer in light of the following detailed description of illustrative embodiments of this invention described in connection with the drawings.

### DESCRIPTION OF THE DRAWINGS

FIG. 1 is a schematic diagram of a cloud design composition negotiation system of an embodiment according to the present invention.

FIG. 2 is a schematic view illustrating initial (first) icons shown on a screen according to the present invention.

FIG. 3 is a view similar to FIG. 2 with icons in area A of FIG. 2 changed.

FIG. 4 is a view similar to FIG. 2 with icons in area B of FIG. 2 changed.

FIG. 5 is a view similar to FIG. 2 with icons in area C of FIG. 2 changed.

FIG. 6 is a schematic view illustrating another (second) icons shown on the screen according to the present invention.

### DETAILED DESCRIPTION OF THE INVENTION

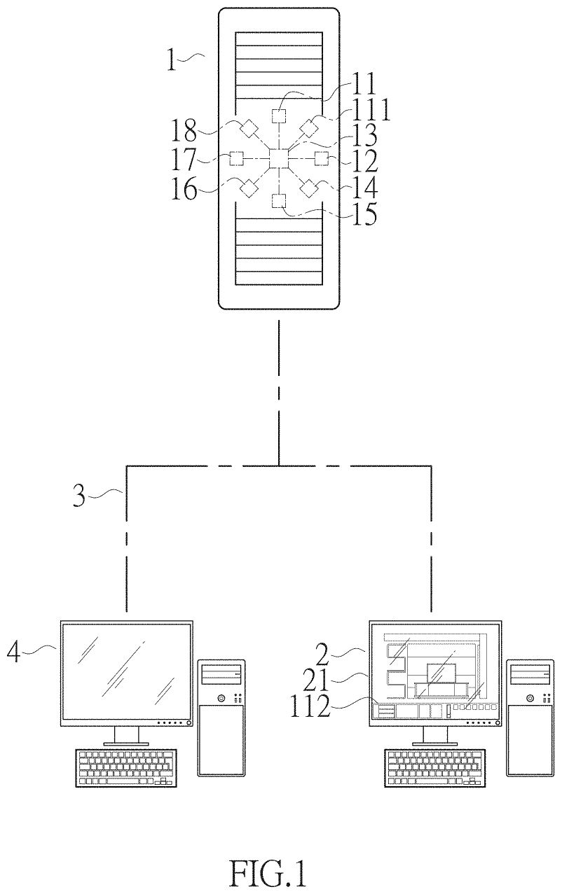

With reference to FIG. 1, a cloud design composition negotiation system according to the present invention comprises a cloud design composition cloud server 1 including a database 11 storing a plurality of design composition data 111. The plurality of design composition data 111 is produced from a composition unit 14 and is uploaded and stored. Manufacturers of compositions can produce a huge icon data base through mass production.

The cloud design composition server 1 includes a partial change program 12 for executing a portion of the composition. The partial change program 12 can be linked to access variable data in a variable data section 14. A processing unit 13 in the cloud design composition server 1 executes the partial change of the design composition data 111.

The cloud design composition negotiation system further comprises an execution end operating unit 2, which can be a desktop computer, a notebook computer, a tablet, or a cell phone of a proprietor, or any equipment at any place for operating or displaying the cloud design composition server 1.

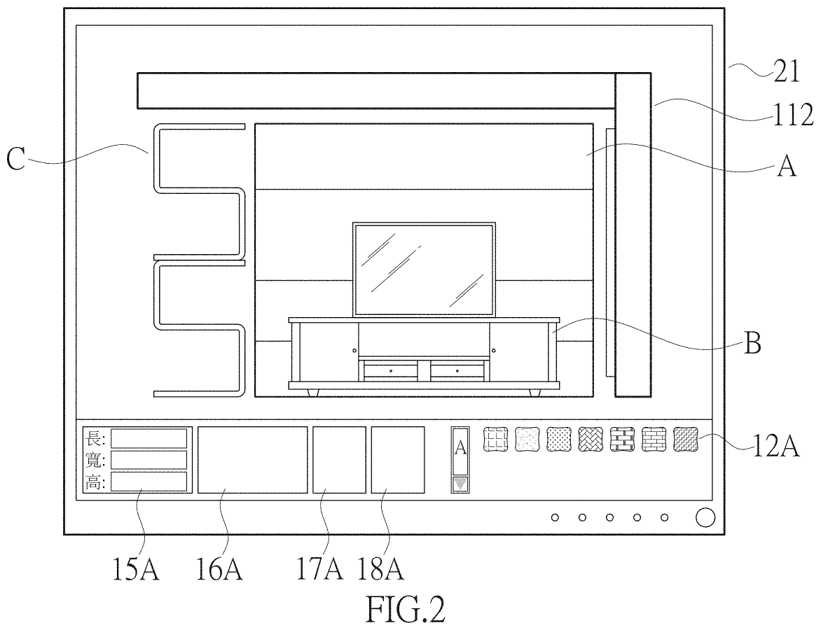

The execution end operating unit 2 and the database 11 can be connected via the internet 3. The execution end operating unit 2 can access the plurality of design composition data 111 through clicking, such that icons 112 of the composition can be displayed on a screen 21 of the execution end operating unit 2, as shown in FIG. 2. In the example shown in FIG. 2, the icons 112 of the composition present a television cabinet and its peripheral design icons.

The cloud design composition server 1 according to the present invention includes a style selection program 17 and an area selection program 18. The style selection program 17 and the area selection program 18 can be executed to present a style selection icon 17A and an area selection icon 18A on the screen 21.

The partial change program 12 according to the present invention can present a partial change icon 12A on the screen 21. The partial change icon 12A can be clicked to access the variable data section 14, such that a user at the execution end can proceed with partial modification on the icons 112 of the composition.

The cloud design composition server 1 includes a size input program 15 configured to present a compute icon 15A for size input on the screen 21. The size input program 15 can be linked to a pricing program 16 configured to present a price column 16A for showing the price on the screen 21. When the size (length, width, and height) is inputted through the execution end operating unit 2, the price for the composition can be calculated.

With reference to FIG. 2, when the execution end operator (namely, a proprietor) clicks and chooses a style selection icon 17A (such as European style, ocean style, or Japanese style) and an area selection icon 18A (such as a living room, a kitchen, or a bedroom), thereby obtaining the plurality of design composition data 111. Thus, the icons 112 of the first (or initial) composition are presented on the screen 21 of the execution end operating unit 2, as shown in FIG. 2. In the example shown in FIG. 2, the icons 112 present a television cabinet and its peripheral design icons in a plain style.

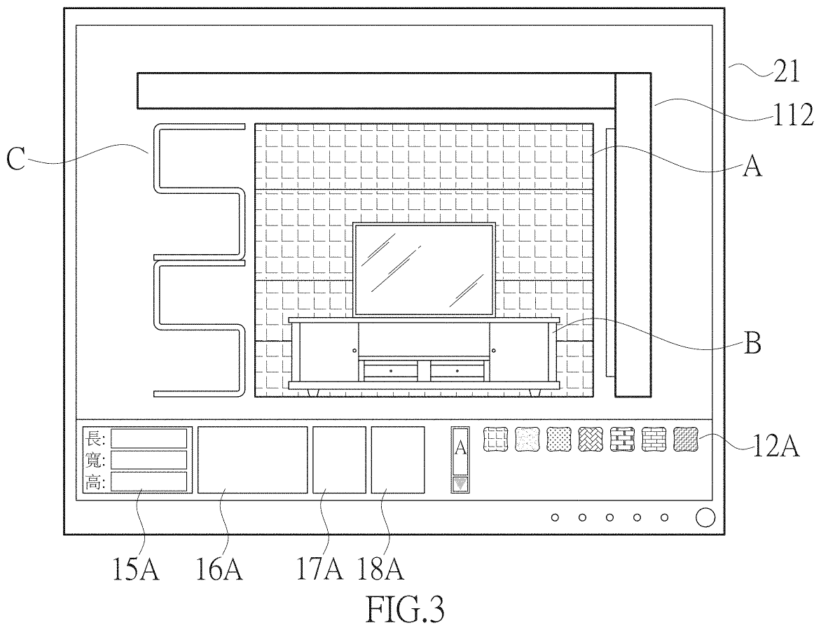

With reference to FIG. 3, in a case that the execution end operator is not satisfied with the material icons of the icons 112 in a television wall area A in the first (or original) composition, the partial change icon 12A can be clicked to access the variable data section 14, permitting the execution end user to proceed with partial modification on the icons 112 of the composition. For example, the variable data section 14 can exhibit data including the material, color, or pattern.

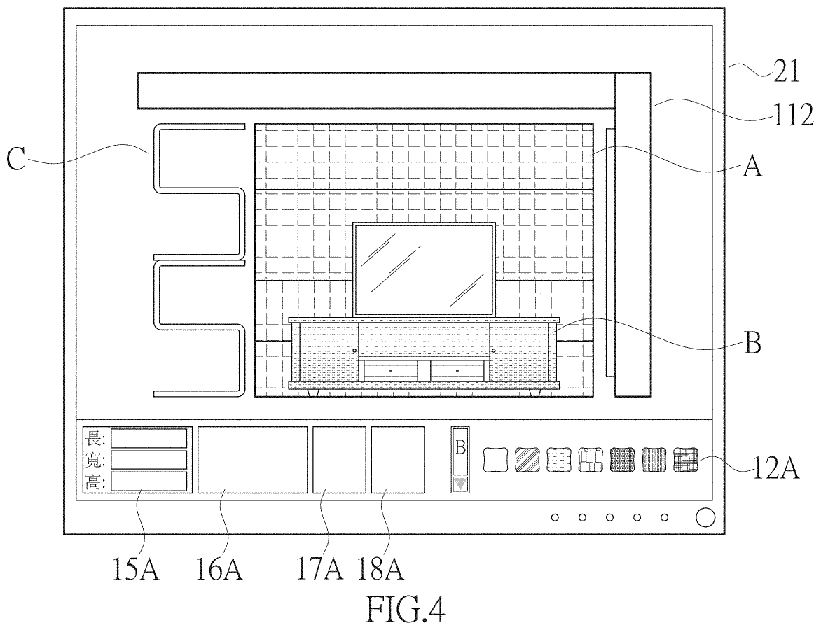

With reference to FIG. 4, in a case that the execution end operator is not satisfied with the material icons in a television cabinet area B, the partial change icon 12A can be clicked to access the variable data section 14, permitting the execution end user to proceed with partial modification on the icons 112 of the composition, such as the material data in the variable data section 14.

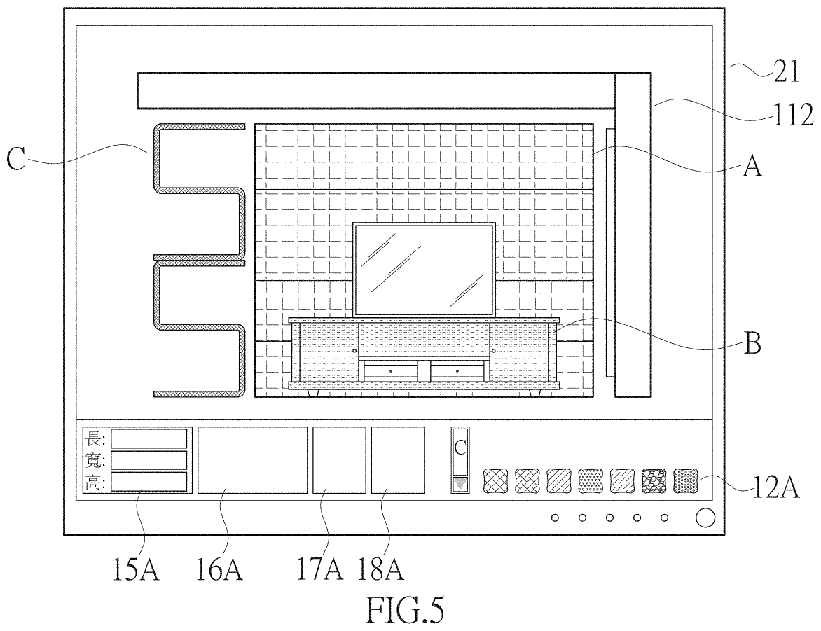

With reference to FIG. 5, in a case that the execution end operator is not satisfied with the material icons in a television cabinet area C, the partial change icon 12A can be clicked to access the variable data section 14, permitting the execution end user to proceed with partial modification on the icons 112 of the composition, such as the material data in the variable data section 14.

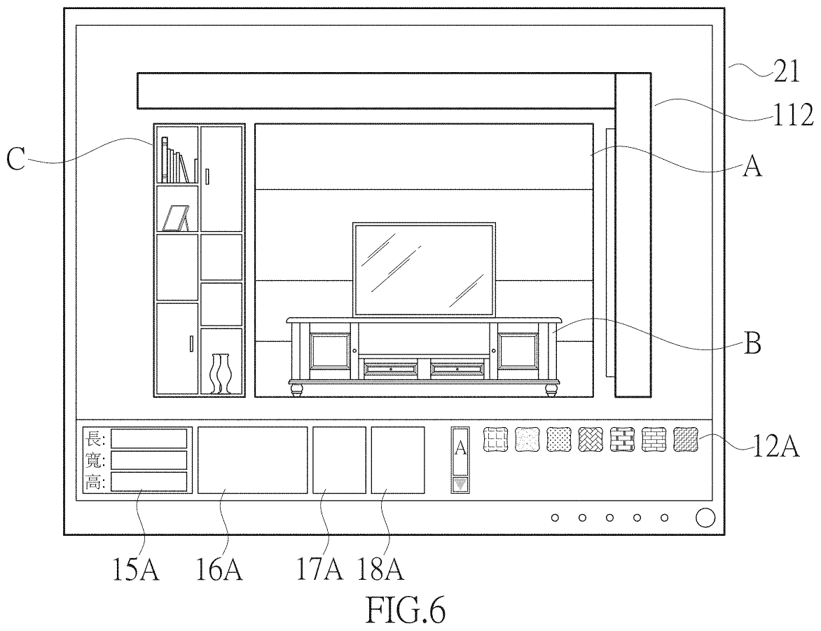

With reference to FIG. 6, in a case that the execution end operator is not satisfied with the icons 112 of the whole composition, he or she can click another of the plurality of design composition data 111, such as a second set of icons 112, which can be shown on the screen 21 of the execution end operating unit 2. As to the partial modification or change, partial changes illustrated in FIGS. 3-5 can be proceeded.

Thus, the proprietor can operate the execution end operating unit 2 to link with the database 11 via the Internet 3, and the plurality of design composition data 111 on the screen 21 can be clicked to show the respective design composition data on the screen 21. Then, the proprietor can view the icons 112 presented by the design composition data 111 and can express opinions on and participate in partial modification of the respective design composition data 111 on the screen 21. The concrete modification can be transmitted to the composition worker for proceeding with detailed construction drawings.

The detailed construction drawings obtained from the interaction between two parties can be provided by proprietor to the worker for working. The following advantages can be obtained. The cloud design composition negotiation system according to the present invention enables composition workers to directly communicate with the proprietor without the need of permanent personnel, and the provision of cloud data saves the manpower and the time required for traffic. Furthermore, the design composition data stored in the huge database satisfies various ideas of the proprietor in the contours and spatial layouts. Furthermore, the proprietor, even without high design specialty, can participate in the modification, and such modification can be easily achieved through clicking operation of the execution end operating unit 2 (such as a computer, a tablet, or a cell phone). Furthermore, the communication between two parties can be recorded in the cloud via the Internet and related computer equipment, which leaves a record for checking and evidence in the future.

Although specific embodiments have been illustrated and described, numerous modifications and variations are still possible without departing from the scope of the invention. The scope of the invention is limited by the accompanying claims.

What is claimed is:

1. A cloud design composition negotiation system comprising:
a cloud design composition server including a database in which a plurality of design composition data is stored, wherein the cloud design composition server further includes a partial change program configured to link with a variable data section and to access variable data in the variable data section, wherein the cloud design composition server further includes a processing unit configured to execute partial change in the plurality of design composition data, and wherein the cloud design composition server further includes a style selection program and an area selection program, and
an execution end operating unit configured to link with the database and including a screen, wherein the execution end operating unit is operable by clicking the style selection program and the area selection program to present a style selection icon and an area selection icon on the screen, thereby obtaining a selected one of the plurality of design composition data, wherein icons of a composition of the selected one of the plurality of design composition data are shown on the screen, wherein the partial change program is configured to present a partial change icon on the screen, and wherein clicking the partial change icon enables an execution end user to access the variable data section to thereby proceed with partial change in the icons of the composition.

2. The cloud design composition negotiation system as claimed in claim 1, wherein the variable data section includes material data.

3. The cloud design composition negotiation system as claimed in claim 1, wherein the cloud design composition server further includes a size input program which is configured to present a computer icon for size input on the screen, wherein the size input program is configured to link with a pricing program which is configured to present a price column on the screen, and wherein when a size is inputted through the execution end operating unit, a price is calculated and shown in the price column.
